(19) United States
(12) Patent Application Publication
(10) Pub. No.: US 2004/0092184 A1
(43) Pub. Date: May 13, 2004

(54) Flame-retardant substrate

(76) Inventor: Rus Kingman, Las Vegas, NV (US)

Correspondence Address: TOPE-MCKAY & ASSOCIATES, 23852 PACIFIC COAST HIGHWAY #311, MALIBU, CA, 90265, US

(21) Appl. No.: 10/293,212

(22) Filed: Nov. 12, 2002

(51) Int. Cl. B32B 27/12; B27N 9/00; B32B 27/04; B32B 5/02; B32B 9/04

(52) U.S. Cl. 442/136; 428/920; 428/921; 442/152; 442/139; 442/141; 442/153; 442/65

(57) ABSTRACT

A flame-retardant substrate is present herein. The flame-retardant substrate includes a material layer surrounded by a flame-retardant coating. The coating is made of a chemical mixture that serves as a flame retardant barrier when exposed to fire. The flame-retardant substrate may be attached beneath the upholstery or surface layer of a textile-based item such as a piece of furniture or mattress. As such, the flame-retardant substrate serves as a barrier to flame to which the item is exposed while further impairing the further spread of fire.

### BACKGROUND OF THE INVENTION

(1) Technical Field

The present invention relates to a flame-retardant substrate and method of making such. More specifically, the present invention relates to a multi-layered flame-retardant substrate that protects textile-based items, such as furniture and clothing, by serving as a flame-retardant barrier.

(2) Discussion

In the event of a fire, preventing the fire's spread is often of utmost importance. Thus, flame-retardant substrates and materials are important safety components of many products and designs. Currently available fire-resistant and flame-retardant materials include flame-retardant additives which are added to an existing substance or material to reduce flammability. Other material-based means of reducing flammability include the use of a fire-resistant yarn and single and bi-layer flame-retardant materials. Such flame-retardant materials are comprised of components that include aramid fibers and resins, glass filaments, and fiberfill bott, and are to be used in place of normal materials in the design of many products such as furniture and apparels.

Largely due to the adoption of strict new codes and standards of fire protection, it has become important to develop a flame-retardant substrate which can be used as a barrier to enhance the fire retardation of everyday materials and fabrics. For instance, in the state of California, the Department of Consumer Affairs have issued Technical Bulletin 117 (March 2000) and Technical Bulletin 129 (October 1992), which provides detailed guidelines for testing the flame retardance of filling materials used in upholstered furniture and for testing the flammability of mattresses to be used in public buildings respectively (Appendix A). One major requirement of such standards is a component material test in which each component of the subject item is tested in order to take into consideration the interaction between its materials and design. Although these are specifically California requirements, a number of major furniture manufacturers and retailers report that they currently make or sell only Technical Bulletin 117 and 129 compliant furniture, regardless of where in the United States the furniture is sold. Thus, in essence, such regulations have become an unofficial, benchmark, flammability standard for residential, upholstered furniture and mattresses sold in the United States.

Accordingly, there exists a need in the art for a flame-retardant substrate for use in conjunction with existing textile-based items which complies with many of today's fire safety standards. There is also a need for a process of making the flame-retardant substrate to meet the aforementioned requirements in a practical and economically feasible manner.

### SUMMARY OF THE INVENTION

The present invention relates to a flame-retardant substrate having a first layer of flame-retardant coating, a material layer and a second layer of flame-retardant coating such that the material layer is substantially coated with the flame-retardant coating from above and below.

In one aspect of the invention the material layer is a cellulosic substrate, where in an additional aspect this cellulosic substrate is a cotton-weave substrate.

Additionally, the material layer may be about 2.5 ounces per square yard in weight and/or a cotton-weave substrate that has about 63 warp ends and about 44 filling picks.

The flame-retardant substrate, in one aspect, is a component of a textile-based item such as a mattress, an item of upholstered furniture, an article of clothing, an item of apparel, or a sleeping bag.

The first and second layers of flame-retardant coating are made from a mixture of chemicals comprising decabromidiphenyl oxide, isodecyl diphenyle phosphate, antimony oxide, and polyurethane polymers.

In one aspect of the invention, the a mixture of chemicals that make up the first and second layers is a mixture of approximately 30.0 percent polyvinyl chloride; 29.0 percent antimony trioxide decabromodiphenyl oxide; 1.0 percent ammonium hydroxide; 1.0 percent cotton flock; 15.0 percent phosphate; 10.0 percent emulsified tricresyl phosphate; 5.0 percent aluminum trihydroxide, and 9.0 percent polyacrylate.

The present invention also relates to a method of forming a flame-retardant substrate which includes the steps of: providing a piece of material; adding a chemical mixture to an untreated surface of the material; curing the chemical mixture on the material by applying heat at a rate sufficient to cure the chemical mixture on the material; and repeating the steps for each untreated surface on the material, thereby covering the material with a coating to form a fire-retardant substrate.

In one aspect of the method, adding the chemical mixture may include adding a chemical mixture comprising of decabromidiphenyl oxide, isodecyl diphenyle phosphate, antimony oxide, and polyurethane polymers.

The method of forming a flame-retardant substrate may also include attaching the material to a plurality of pins for moving the material, and in an additional aspect, may include moving the material in a tenter frame.

The moving the material over the surface may include providing the material at a constant width to ensure an even application of the chemical mixture, and may also include positioning the material on a bed of foam rubber.

Additionally, in one aspect the adding of the chemical mixture is at a weight of about 2.0 ounces per square yard of material, while a further aspect provides for transferring the material through a heating area at a speed of approximately 30 yards per minute. The temperature at which the chemical mixture is cured may range from approximately 275 to 325 degrees Fahrenheit, and the heating area may be a gas-fired oven.

The method of forming a flame-retardant substrate may also include lowering a coating head having a flat-edged blade onto the untreated surface of the material; and releasing the chemical mixture from a position behind the blade onto the untreated surface of the material.

Furthermore, the method may involve transferring the material to a roller after curing the chemical mixture on the material, thereby exposing at least one untreated surface of the material.

Additionally, the method may include forming a flame-retardant substrate that is approximately 0.015 inches thick.

The present invention also provides for a method of reducing the flammability of a textile-based item which includes the step of positioning a flame-retardant substrate beneath the surface of a textile-based item, where the flame-retardant substrate includes a material core, at least one first layer, and at least one second layer. In one aspect of the invention, the first layer and the second layer are made of a chemical mixture comprising: decabromidiphenyl oxide, isodecyl diphenyle phosphate, antimony oxide, and polyurethane polymers.

The textile-based item may be a mattress, an item of upholstered furniture, an article of clothing, an item of apparel, or a sleeping bag, while the chemical mixture may be made up of approximately 30.0 percent polyvinyl chloride; 29.0 percent antimony trioxide decabromodiphenyl oxide; 1.0 percent ammonium hydroxide; 1.0 percent cotton flock; 15.0 percent phosphate; 10.0 percent emulsified tricresyl phosphate; 5.0 percent aluminum trihydroxide, and 9.0 percent polyacrylate.

Furthermore, the present invention may include a method of producing chemical coating for forming a flame-retardant substrate which includes the step of combining decabromidiphenyl oxide, isodecyl diphenyle phosphate, antimony oxide, and polyurethane polymers. In one aspect, this includes combining approximately 30.0 percent polyvinyl chloride; 29.0 percent antimony trioxide decabromodiphenyl oxide; 1.0 percent ammonium hydroxide; 1.0 percent cotton flock; 15.0 percent phosphate; 10.0 percent emulsified tricresyl phosphate; 5.0 percent aluminum trihydroxide; and 9.0 percent polyacrylate. An additional aspect provides that the combining step is at an ambient temperature.

### BRIEF DESCRIPTION OF THE DRAWINGS

The objects, features and advantages of the present invention will be apparent from the following detailed descriptions of the preferred aspect of the invention in conjunction with reference to the following drawings.

FIG. 1 is a cross-sectional view of one aspect of the present invention in which a flame-retardant substrate has a first and a second layer of flame-retardant coating and a material layer;

FIG. 2 is a process flow diagram of one aspect of a method of making a flame-retardant substrate according to the present invention; and

FIG. 3 is a cross sectional cut-out perspective view of one aspect of the invention having a flame-retardant substrate which is positioned below the cushioned-surface of a mattress to reduce the overall flammability of the mattress.

### DETAILED DESCRIPTION OF PREFERRED ASPECTS

The present invention relates to a flame-retardant substrate and a method of making the flame-retardant substrate. More specifically, the present invention relates to a flame-retardant substrate that may be adapted to a textile-based item to provide a barrier of protection when the item is exposed to fire. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

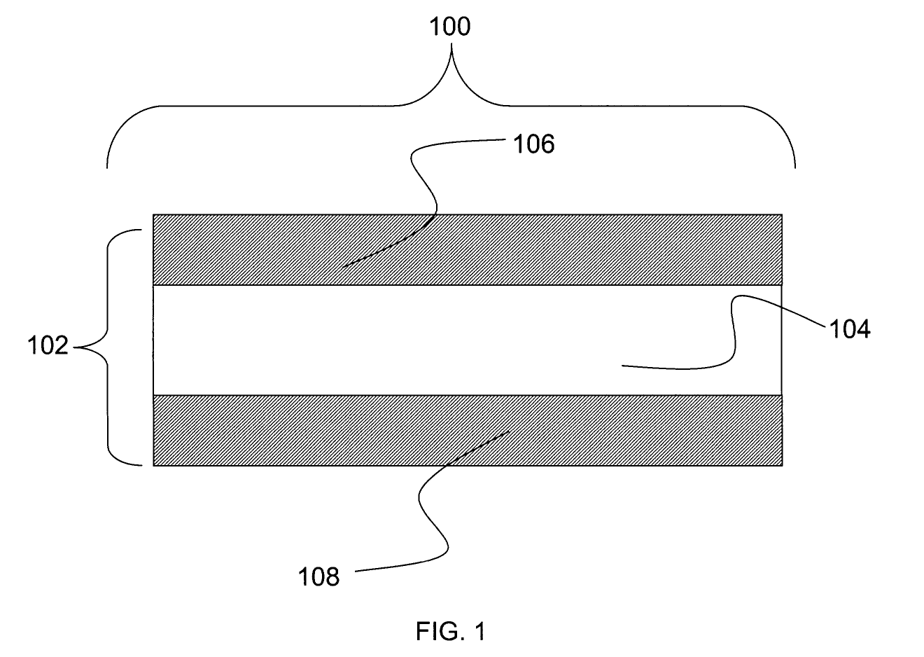

A cross-sectional view of one aspect of the present invention is shown in FIG. 1. In this aspect, a flame-retardant substrate 100 is made of a flame-retardant coating 102 which surrounds a material layer 104. The material layer 104 generally is a cellulosic substrate such as a cotton-weave substrate. In one aspect, the material layer 104 of material has about 63 warp ends and 44 filling picks, while another aspect provides for a material layer 104 that weighs approximately 2.5 ounces per square yard of material.

The flame-retardant coating which surrounds the material layer 104 is comprised of a first layer 106 and a second layer 108. The first layer 106 and the second layer 108, in one aspect, are made of a chemical mixture of decabromodiphenyl oxide, isodecyl diphenyle phosphate, antimony oxide, and polyurethane polymers. More specifically, an example chemical mixture is comprised of approximately 30.0 percent polyvinyl chloride; 29.0 percent antimony trioxide decabromodiphenyl oxide; 1.0 percent ammonium hydroxide; 1.0 percent cotton flock; 15.0 percent phosphate; 10.0 percent emulsified tricresyl phosphate; 5.0 percent aluminum trihydroxide, and 9.0 percent polyacrylate. When taken as a whole, in one aspect, the material layer 104, the first layer 106, and the second layer 108 form the flame-retardant substrate 100 which is approximately 54 inches±2 inches to 90±2 inches wide and 0.015±0.005 inches thick. The weight of the flame-retardant substrate 100 may typically be about 6.0±0.5 ounces per square yard.

When exposed to a flame or heat, the multi-layer configuration of the flame-retardant substrate 100 enhances its ability to protect a textile-based item. For example, if a flame or heat is applied to the first layer 106, the coating, rather than the material layer 104 burns and thereby forms a crust or shell-like layer. This crusted layer further prevents the material layer 104 from combusting. The second layer 108 functions in a manner similar to that of the first layer 106. As such, when the fire retardant substrate 100 is properly positioned beneath the surface of a textile-based item, the item is protected from the harmful affects of flame exposure and combustion because of the “barrier” provided by the flame-retardant substrate 100. That is, although the first surface of the textile-based item ignites, the flame-retardant substrate 100 positioned beneath this surface, serves as a barrier, thereby protecting the core of the item. As a result, the core of the item is protected, which in turn helps maintain the item's form and thus eliminate a source of fuel for the fire.

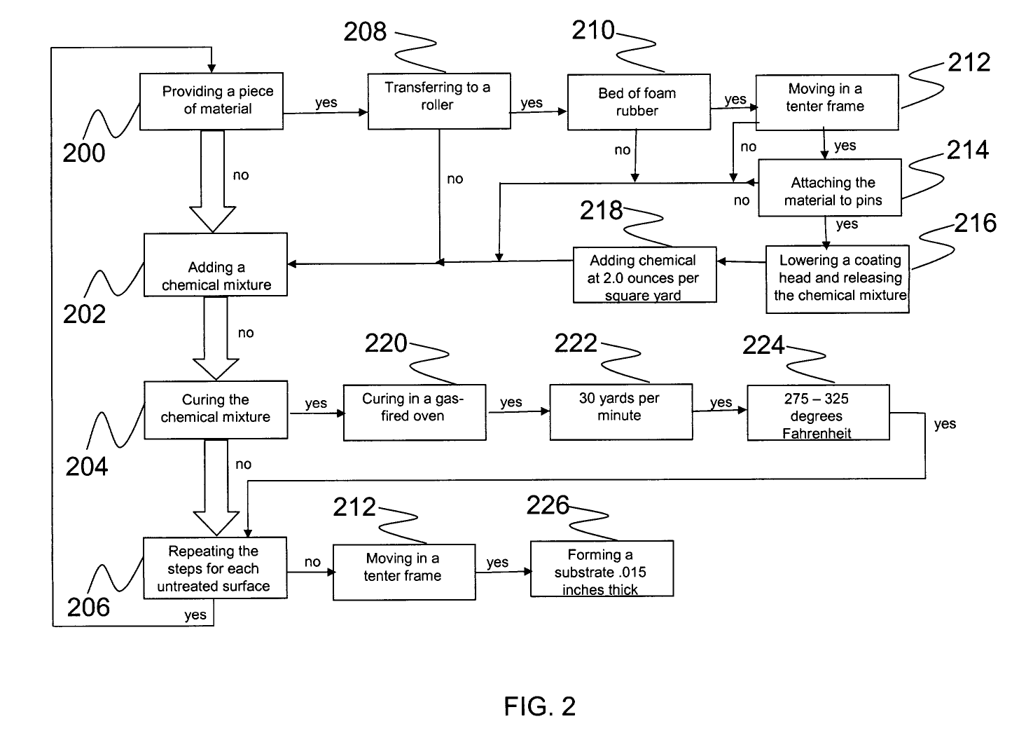

A method of producing the flame-retardant substrate 100 shown in the process flow diagram in FIG. 2. In this aspect, the method involves the steps of providing 200 a piece of material 104; adding a chemical mixture 202 to at least one untreated surface of the material 104; curing 204 the chemical mixture on the material 104 by applying heat at a rate sufficient to cure the chemical mixture on the material 104; and repeating 206 the steps for each untreated surface on the material 104, thereby covering the material 104 with a coating to form a fire-retardant substrate 100

Additional steps may be applied in producing the flame-retardant substrate 100. For example, the method may involve transferring 208 the material 104 to a roller, such as a conveyer belt or other material handling device for providing 202 the material 104. In one aspect, providing 202 the material 104 may include positioning 210 the material on a covered bed of foam rubber, and moving 212 the material 104 though a tenter frame, which may be, but is not limited to, tenter ovens such as those commonly used in the art. The method may also include attaching 214 a series of pins to the material 104 in order to move the material 104 at a desired width. As the material 104 travels over the surface, the chemical mixture, as described in reference to FIG. 1, is added to the material 104, thereby coating an exposed surface of the material 104. The adding of the chemical mixture may occur by lowering a coating head 216 having a flat-edge blade, of the type commonly used by those skilled in the art, to a point just above the material 104 and releasing the chemical mixture. The chemical mixture, which generally is positioned behind a blade on the coating head, coats the upper exposed surface of the material 104 at a weight of approximately 2.0 ounces per square yard 218.

As the exposed upper surface of the material 104 which has been coated by the chemical mixture is cured, the first layer 106 of the flame-retardant substrate 100 is formed. In one aspect, the curing 204 of the material layer 104 occurs in an oven, and, even more particularly, a gas-fired oven 220. The step of curing the chemical mixture may occur at the rate of about 30 yards of material per minute 222, at a temperature in the range of approximately 275 to 325 degrees Fahrenheit 224. The aforementioned steps are repeated 206 for each untreated surface of the material layer 104 as the material layer 104 is carried on the roller 212. The result, in one aspect, is the forming 226 a flame-retardant substrate 100 that is approximately 0.015 inches thick and in accord with that described in FIG. 1.

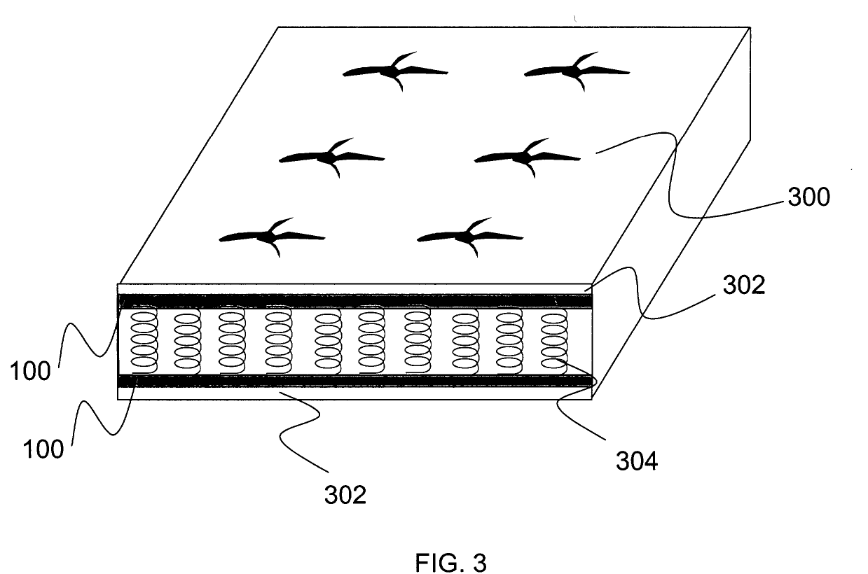

FIG. 3 shows a mattress 300 incorporating the flame-retardant substrate 100 of the present invention. The flame-retardant substrate 100 is positioned beneath the mattress's outer surface 302, which is traditionally an embroidered fabric. Together, the outer surface 302 and the flame-retardant substrate 100 cover the interior 304 of the mattress. Thus, in this aspect, the flame-retardant substrate 100 serves as a flame-retardant barrier to protect the textile-based interior 304 of the mattress, thereby reducing the flammability of the mattress when exposed to fire. For example, when the surface 302 of the mattress 300 ignites, the flame-retardant substrate 100 which is positioned beneath this surface 302, serves as a barrier, as described in reference to FIG. 1, and thereby protects the mattress's interior 304. As a result, the interior 304 of the mattress is shielded from the flame. This in turn helps to maintain the form of the mattress 300 while also decreasing the availability of the mattress's interior 304 components, such as foam, wood, and other textiles, which are significant potential sources of fuel for the fire.

The aspect provided in FIG. 3 is a general example of the use of the flame-retardant substrate 100 and is not intended to be limiting. That is, the flame-retardant substrate 100 of the present invention serve as a flame-retardant barrier for items such as, but not limited to, upholstered-furniture, clothing and apparel, sleeping bags, and similar textile-based items for which a reduction in flammability is necessary or desirable. It should also be appreciated that the flame-retardant substrate 100 may be made in a wide variety of shapes and sizes to conform to the preferred textile-based item.

The process by which the flame-retardant substrate 100 is made also may be varied accordingly. For example, any effective means of applying the chemical mixture, moving and stabilizing the material layer 104 and the flame-retardant substrate 100, or curing the flame-retardant substrate 100 may be used. It is also possible that any suitable heating means may be utilized and the rate of the curing process may be varied accordingly to compensate for the different heating environments. Furthermore, a similar processing apparatus, rather than the tenter frame and roller described may be used to accomplish essentially the same final results.

What is claimed is:

1. A flame-retardant substrate comprising:
a first layer of flame-retardant coating;
a material layer having a first surface and a second surface, wherein the first layer of flame-retardant coating covers at least a portion of the first surface of the material layer; and
a second layer of flame-retardant coating covering at least a portion of the second surface of the material layer, whereby the material layer is substantially coated with the flame-retardant coating.

2. The flame-retardant substrate, as set forth in claim 1, wherein the material layer is comprised of a cellulosic substrate.

3. The flame-retardant substrate, as set forth in claim 2, wherein the cellulosic substrate is a cotton-weave substrate.

4. The flame-retardant substrate, as set forth in claim 3, wherein the material layer is about 2.5 ounces per square yard in weight.

5. The flame-retardant substrate, as set forth in claim 4, wherein the material layer is a cotton-weave substrate has about 63 warp ends and about 44 filling picks.

6. The flame-retardant substrate, as set forth in claim 1, wherein the material layer is a cotton-weave substrate.

7. The flame-retardant substrate, as set forth in claim 1, wherein the material layer is about 2.5 ounces per square yard in weight.

8. The flame-retardant substrate, as set forth in claim 1, wherein the material has about 63 warp ends and about 44 filling picks.

9. The flame-retardant substrate, as set forth in claim 1, wherein the flame-retardant substrate is positioned beneath an outer surface of a textile-based item selected from a group comprising: a mattress, an item of upholstered furniture, an article of clothing, an item of apparel, and a sleeping bag.

10. The flame-retardant substrate, as set forth in claim 1, wherein the first layer of flame-retardant coating and the second layer of flame-retardant coating are a mixture of chemicals comprising: decabromidiphenyl oxide, isodecyl diphenyle phosphate, antimony oxide, and polyurethane polymers.

11. The flame-retardant substrate, as set forth in claim 10, wherein the material layer is comprised of a cellulosic substrate.

12. The flame-retardant substrate, as set forth in claim 11, wherein the material layer is about 2.5 ounces per square yard in weight.

13. The flame-retardant substrate, as set forth in claim 12, wherein the material layer is a cotton-weave substrate having about 63 warp ends and about 44 filling picks.

14. The flame-retardant substrate, as set forth in claim 13, wherein the flame-retardant substrate is positioned beneath an outer surface of a textile-based item selected from a group comprising: a mattress, an item of upholstered furniture, an article of clothing, an item of apparel, and a sleeping bag.

15. The flame-retardant substrate, as set forth in claim 10, wherein the material layer is about 2.5 ounces per square yard in weight.

16. The flame-retardant substrate, as set forth in claim 10, wherein the material layer is a cotton-weave substrate having about 63 warp ends and about 44 filling picks.

17. The flame-retardant substrate, as set forth in claim 10, wherein the flame-retardant substrate is positioned beneath an outer surface of a textile-based item selected from a group comprising: a mattress, an item of upholstered furniture, an article of clothing, an item of apparel, and a sleeping bag.

18. The flame-retardant substrate, as set forth in claim 1, wherein the first layer of flame-retardant coating and the second layer of flame-retardant coating are comprised of a mixture of chemicals comprising approximately:
30.0 percent polyvinyl chloride;
29.0 percent antimony trioxide decabromodiphenyl oxide;
1.0 percent ammonium hydroxide;
1.0 percent cotton flock;
15.0 percent phosphate;
10.0 percent emulsified tricresyl phosphate;
5.0 percent aluminum trihydroxide, and
9.0 percent polyacrylate.

19. The flame-retardant substrate, as set forth in claim 18, wherein the material layer is comprised of a cellulosic substrate

20. The flame-retardant substrate, as set forth in claim 19, wherein the material layer is about 2.5 ounces per square yard in weight.

21. The flame-retardant substrate, as set forth in claim 20, wherein the material layer is a cotton-weave substrate having about 63 warp ends and about 44 filling picks.

22. The flame-retardant substrate, as set forth in claim 21, wherein the flame-retardant substrate is positioned beneath an outer surface of a textile-based item selected from a group comprising: a mattress, an item of upholstered furniture, an article of clothing, an item of apparel, and a sleeping bag.

23. The flame-retardant substrate, as set forth in claim 18, wherein the material layer is about 2.5 ounces per square yard in weight.

24. The flame-retardant substrate, as set forth in claim 18, wherein the material layer is a cotton-weave substrate having about 63 warp ends and about 44 filling picks.

25. The flame-retardant substrate, as set forth in claim 18, wherein the flame-retardant substrate is positioned beneath an outer surface of a textile-based item selected from a group comprising: a mattress, an item of upholstered furniture, an article of clothing, an item of apparel, and a sleeping bag.

26. A method of forming a flame-retardant substrate comprising steps of:
providing a piece of material to be coated;
adding a chemical mixture to at least one untreated surface of the material;
curing the chemical mixture on the material by applying heat at a rate sufficient to cure the chemical mixture on the material; and
repeating the steps for each untreated surface on the material, thereby covering the material with a coating to form a fire-retardant substrate.

27. The method of forming a flame-retardant substrate, as set forth in claim 26, wherein the step of providing a piece of material further comprises steps of attaching the material to a plurality of pins and moving the material over a surface.

28. The method of forming a flame-retardant substrate, as set forth in claim 27, wherein moving the piece of material further comprises moving the material in a tenter frame.

29. The method of forming a flame-retardant substrate, as set forth in claim 28, further comprising a step of moving the material at a constant width to ensure an even application of the chemical mixture.

30. The method of forming a flame-retardant substrate, as set forth in claim 29, wherein the step of providing the material includes a step of placing the material on a bed of foam rubber.

31. The method of forming a flame-retardant substrate, as set forth in claim 30, further comprising a step of adding the chemical mixture at a weight of about 2.0 ounces per square yard of material.

32. The method of forming a flame-retardant substrate, as set forth in claim 31, further comprising a step of transferring the material through a heating area at a speed of approximately 30 yards per minute.

33. The method of forming a flame-retardant substrate, as set forth in claim 32, wherein the step of curing the chemical mixture further comprises applying heat at a temperature ranging from approximately 275 to 325 degrees Fahrenheit.

34. The method of forming a flame-retardant substrate, as set forth in claim 33, further comprising the steps of:
lowering a coating head having a flat-edged blade onto the untreated surface of the material; and
releasing the chemical mixture from a position behind the blade onto the untreated surface of the material.

35. The method of forming a flame-retardant substrate, as set forth in claim 34, wherein the step of curing the chemical mixture includes curing within a gas-fired oven.

36. The method of forming a flame-retardant substrate, as set forth in claim 35, further comprising a step of transferring the material to a roller after curing the chemical mixture on the material, thereby exposing at least one untreated surface of the material.

37. The method of forming a flame-retardant substrate, as set forth in claim 36, further comprising a step of forming a flame-retardant substrate having a thickness of approximately 0.015 inches.

38. The method of forming a flame-retardant substrate, as set forth in claim 37, wherein the chemical mixture is comprised of decabromidiphenyl oxide, isodecyl diphenyle phosphate, antimony oxide, and polyurethane polymers.

39. The method of forming a flame-retardant substrate, as set forth in claim 26, wherein the step of providing a piece of material further comprises moving the material in a tenter frame.

40. The method of forming a flame-retardant substrate, as set forth in claim 26, further comprising a step of moving the material at a constant width to ensure an even application of the chemical mixture.

41. The method of forming a flame-retardant substrate, as set forth in claim 26, wherein the step of providing a material further comprises placing the material on a bed of foam rubber.

42. The method of forming a flame-retardant substrate, as set forth in claim 26, further comprising the step of adding the chemical mixture at a weight of about 2.0 ounces per square yard of material.

43. The method of forming a flame-retardant substrate, as set forth in claim 26, further comprising the step of transferring the material through a heating area at a speed of approximately 30 yards per minute.

44. The method of forming a flame-retardant substrate, as set forth in claim 26, wherein the step of curing the chemical mixture further comprising applying heat at a temperature ranging from approximately 275 to 325 degrees Fahrenheit.

45. The method of forming a flame-retardant substrate, as set forth in claim 26, further comprising the steps of:
lowering a coating head having a flat-edged blade onto the untreated surface of the material; and
releasing the chemical mixture from a position behind the blade onto the untreated surface of the material.

46. The method of forming a flame-retardant substrate, as set forth in claim 26, wherein the step of curing the chemical mixture includes curing within a gas-fired oven.

47. The method of forming a flame-retardant substrate, as set forth in claim 26, further comprising the step of transferring the material after curing the chemical mixture on the material to a roller thereby exposing at least one untreated surface of the material.

48. The method of forming a flame-retardant substrate, as set forth in claim 26, further comprising the step of forming a flame-retardant substrate having a thickness of approximately 0.015 inches.

49. The method of forming a flame-retardant substrate, as set forth in claim 26, wherein the chemical mixture is comprised of decabromidiphenyl oxide, isodecyl diphenyle phosphate, antimony oxide, and polyurethane polymers.

50. A method of reducing the flammability of a textile-based item comprising a step of: positioning a flame-retardant substrate beneath a surface of a textile-based item, wherein the flame-retardant substrate comprises:
a material core,
at least one first layer, and
at least one second layer.
wherein the first layer and the second layer are comprised of a chemical mixture comprising: decabromidiphenyl oxide, isodecyl diphenyle phosphate, antimony oxide, and polyurethane polymers.

51. A method of reducing the flammability of a textile, as set forth in claim 50, wherein the first layer and the second layer are comprised of a chemical mixture comprising: decabromidiphenyl oxide, isodecyl diphenyle phosphate, antimony oxide, and polyurethane polymers.

52. A method of reducing the flammability of a textile, as set forth in claim 51, wherein the chemical mixture comprises approximately:
30.0 percent polyvinyl chloride;
29.0 percent antimony trioxide decabromodiphenyl oxide;
1.0 percent ammonium hydroxide;
1.0 percent cotton flock;
15.0 percent phosphate;
10.0 percent emulsified tricresyl phosphate;
5.0 percent aluminum trihydroxide, and
9.0 percent polyacrylate.

53. A method of reducing the flammability of a textile, as set forth in claim 52, wherein the textile-based item is an item selected from a group comprising: a mattress, an item of upholstered furniture, an article of clothing, an item of apparel, and a sleeping bag

54. A method of producing chemical coating for forming a flame-retardant substrate comprising the step of combining decabromidiphenyl oxide, isodecyl diphenyle phosphate, antimony oxide, and polyurethane polymers.

55. A method of producing chemical coating for forming a flame-retardant substrate, as set forth in claim 54, wherein the step of combining includes combining approximately:
30.0 percent polyvinyl chloride;
29.0 percent antimony trioxide decabromodiphenyl oxide;
1.0 percent ammonium hydroxide;
1.0 percent cotton flock;
15.0 percent phosphate;
10.0 percent emulsified tricresyl phosphate;
5.0 percent aluminum trihydroxide, and
9.0 percent polyacrylate.

56. A method of producing chemical coating for forming a flame-retardant substrate, as set forth in claim 55, further comprising the step of combining is at an ambient temperature.

57. A method of producing chemical coating for forming a flame-retardant substrate, as set forth in claim 54, further comprising the step of combining is at an ambient temperature.
